(19) United States
(12) Patent Application Publication
(10) Pub. No.: US 2009/0077032 A1
(43) Pub. Date: Mar. 19, 2009

(54) CALM CAPABLE OF SEARCHING AGENT SERVICE THROUGH WEB, AGENT SYSTEM USING THE SAME AND OPERATION METHOD OF AGENT SYSTEM

(76) Inventors: DONG RYEOL SHIN, Gunpo-si (KR); Geon Ha Lee, Samcheok-si (KR); Dong Uk Kim, Seoul (KR); Sung Jun Na, Seoul (KR); Yoe Jin Yoon, Gongju-si (KR); Yi Seok Jeong, Busan (KR); Seung Hyun Lee, Seoul (KR); Kee Hyun Choi, Suwon-si (KR)

Correspondence Address: LEXYOUME IP GROUP, LLC, 5180 PARKSTONE DRIVE, SUITE 175, CHANTILLY, VA, 20151, US

(21) Appl. No.: 12/016,487

(22) Filed: Jan. 18, 2008

(30) Foreign Application Priority Data
Sep. 17, 2007 (KR) 10-2007-0093996

(51) Int. Cl. G06F 17/30; G06F 7/00

(52) U.S. Cl. 707/3; 707/10; 707/E17.108; 707/E17.01

(57) ABSTRACT

The present invention discloses a CALM capable of the client's determining the CALM storing a service rapidly and accurately, and searching the service by accessing the corresponding CALM, and service agent's preparing the base environment in which a service agent for providing the service the Web can inform a client of the service agent's service by enabling the client to access a CALM-based directory facilitator through a Web server, and an agent service using the CALM.

### BACKGROUND OF THE INVENTION

1. Field of the Invention

The present invention relates to a CALM capable of searching an agent service through Web, an agent system using the same and an operation method of the agent system; and, more particularly, to a CALM to provide a base environment capable of searching a desired service more rapidly and conveniently by enabling a client to access a Web-based directory facilitator through a Web server, an agent system using the same and an operation method of the agent system.

2. Background of the Related Art

An Internet environment based on Web has allowed users to use various on-line services through networks. Moreover, a computing environment also has been rapidly changed and many technologies related to the networks have been consistently researched.

Herein, on the background of continuously developing many technologies related to the networks, a distributed computing environment based on the network exist; a Web service based on SOAP, COBRA and Java RMI has been researched; and further reached to a GRID computing.

Herein, one of fields in which a research has been actively progressed for the distributed computing environment is just agent field.

Researches on an agent, an agent platform, and a mobile agent have been already established through a lot of discussions. A plurality of agent platforms have been researched on the basis of technologies related to construction of an agent service infrastructure and a research on development of an agent-based context-aware service also has been actively progressed in recent.

These researches give an advance notice of an agent age in which all the jobs will be processed by the agent and services provided by the agent will be used, in the near future.

Herein, the agent is software for actively performing a desired job in behalf of a client. An intelligent agent is software for devising a plan so that the plurality of agents can most efficiently meet a client's requirement in cooperation with each other to realize the plan.

Herein, the intelligent agent needs a function of grasping a client's taste and performing the same so as to offer a result suitable for the client's taste.

Accordingly, a multi-agent system in which one agent provides the service to the client in mutual cooperation with other agents should be able to provide a constant and consistent service support under any circumstances. Furthermore, the multi-agent systems should rapidly provide high-reliability information to meet a client's requirement in mutual cooperation with each other.

In this agent technology, it is important that the client searches a desired service in person, and judges and acts through interagent communication to provide a service suitable for a client's current status.

When the agent needs other agents' helps during carrying out a job on the multi-agent systems, the agent continues to provide the service depending on message communication among the agents by the use of an ACL (Agent Communication Language). Accordingly, in the multi-agent systems, each of the service agents advertise their own services by registering the services in a DF (Directory Facilitator) of a CALM (Component-based Autonomic Layered Middleware) which is a message-oriented middleware. The client can search information on the client's desired service through the directory facilitator.

A general CALM is a middleware prepared for providing a base environment in which an agent's service generated at the agent platform from being supplied by a service agent is identified, registered, and stored, and the stored service can be searched by the client.

Accordingly, when a client searches desired service by accessing the CALM in person, the client sends an ACL-based message of a search request to a CALM-based directory facilitator through a message transport system including an AMS (Agent Management System). The CALM-based director facilitator searches another agent service according to the search request message by parsing the search request message and extracting a content message. When the search is completed, a search result according to the search request message is converted into the ACL-based message and is transmitted to the client through the message transport system.

### SUMMARY OF THE INVENTION

### Technical Problem

However, it could not be confirmed whether or not a client's desired service was stored in a known CALM at the time of searching a service through the known CALM. That is, since the client should confirm whether or not the client's desired service was stored by accessing plural CALMs one by one at the time of searching the service through the known CALM, there was a problem that a search time is increased.

Moreover, the known CALM had a problem that the client should correct parameters corresponding to a service to be searched on a code to search the service and the client needed a general knowledge related to the multi-agent system to search the service provided by the service agent.

Since the client could not easily determine the CALM storing the service provided by the service agent for providing the service to store the service in the CALM, the service agent could not inform the clients of the service agent's service.

Therefore, it is, therefore, an object of the present invention to provide a CALM capable of the client's determining the CALM storing the service rapidly and accurately, and service agent's preparing base environment in which the service agent for providing the service through the Web can inform the client of the service agent's service by enabling the client to access the CALM-based directory facilitator through a Web server, and an agent service using the CALM.

### Technical Solution

In order to achieve the above-mentioned object of the present invention, in accordance with a first aspect of the invention, a CALM capable of searching an agent service through a Web includes a Web-based directory facilitator having a communication module which a Web client accesses, a registry in which the agent service is stored, a service search module for searching the agent service which the Web client requests from the registry, and an invocation module for providing the agent service searched by the service search module to the Web client through the communication module.

Herein, the CALM further includes a CALM-based directory facilitator having a knowledge base in which the agent service provided from a service client is stored, wherein the service search module can search the agent service which the Web client requests among the agent services stored in the knowledge base in case that the agent service which the Web client requests does not exist in the registry, and wherein the invocation module can store the agent service searched in the knowledge base by the service search module in the registry and provide the agent service to the Web client through the communication module.

Herein, the CALM-based directory facilitator can include a synchronization module for restoring modified or deleted agent service in the registry in case that the agent service stored in the knowledge base is modified or deleted.

A content of a service description object of the agent service stored in the registry can be an XML schema (eXtensible Markup Language schema)-based service description including one or more among a serial number given to the agent service, a name of the agent service, location information of the agent service for accessing the agent service, a protocol of the agent service, information on a method of executing the service, a category of the agent service, information on a provider indicating a provider of the agent service, and circumferential information of a location of the agent service.

Herein, the Web-based directory facilitator can further include an authentication module for performing authentication of the Web client in case that the Web client accesses the communication module.

Meanwhile, in order to achieve the above-mentioned object of the present invention, in accordance with a second aspect of the present invention, an agent system capable of searching the agent service through the Web includes a Web server which a Web client accesses and a CALM having a Web-based directory facilitator, wherein the Web-based directory facilitator includes a communication module which a Web client accesses, a registry in which the agent service is stored, a service search module for searching the agent service which the Web client requests from the registry, and an invocation module for providing the agent service searched by the service search module to the Web client through the communication module.

Herein, the agent system further includes the CALM-based directory facilitator having a knowledge base in which the agent service provided from a service client is stored, wherein the service search module can search the agent service which the Web client requests among the agent services stored in the knowledge base in case that the agent service which the Web client requests does not exist in the registry, and wherein the invocation module can store the agent service searched in the knowledge base by the service search module in the registry and provide the agent service to the Web client through the communication module.

Herein, the CALM-based directory facilitator can include a synchronization module for restoring modified or deleted agent service in the registry in case that the agent service stored in the knowledge base is modified or deleted.

A content of a service description object of the agent service stored in the registry is an XML schema (eXtensible Markup Language schema)-based service description including one or more among a serial number given to the agent service, a name of the agent service, location information of the agent service for accessing the agent service, a protocol of the agent service, information on a method of executing the service, a category of the agent service, information on a provider indicating a provider of the agent service, and circumferential information of a location of the agent service.

Herein, plural CALMs are prepared, and the Web server can include a storing unit in which a service list prepared based on a service description of the agent service stored in the registry of the plural CALMs is stored, a communication unit for allowing communication between the communication module of the Web-based directory facilitator and the Web client, and a control unit for displaying the service list to the Web client, allowing the Web client to access any one of the plural CALMs by the communication unit, and updating the service list stored in the service description on the basis of whether or not the agent system searched by the service search module exists or the service description of the agent service provided to the Web client by the invocation module.

The Web-based directory facilitator can further include an authentication module for performing authentication of the Web client in case that the Web client accesses the communication module through the Web server.

Meanwhile, in order to achieve the above-mentioned objects, in accordance with a third aspect of the present invention, a method of operating the agent system capable of searching the agent service through the Web includes the steps of accessing a Web server by the Web client; displaying a service list prepared based on a service description of the agent service to the Web client by the Web server; accessing a CALM in which the agent service to be requested by the Web client is stored by the Web client; searching the agent service which the Web client requests in the registry by the service search module; and providing the agent service which the Web client requests, stored in the registry to the Web client through the communication module by an invocation module.

Herein, the method of operating the agent system can further include the steps of preparing a CALM-based directory facilitator having a knowledge base in which the agent service provided from a service client is stored; searching the agent service which the Web client requests in the knowledge base in case that the agent service which the Web client requests does not exist in the registry in view of a search result by the service search module; and storing the agent service searched in the knowledge base by the service search module in the registry by the invocation module and providing the agent service to the Web client through the communication module by the invocation module.

Herein, the method of operating the agent system can further include the steps of preparing the CALMs in multiple; storing the service list prepared based on the service description of the agent service stored in the registry of the plural CALMs in the Web server; displaying the service list to the Web client accessing the Web server; accessing any one communication module in which the agent service which the Web client requests among the CALMs through the Web server by the Web client; and updating the service list on the basis of whether or not the agent system searched by the service search module exists or the service description of the agent service provided to the Web client by the invocation module.

The method of operating the agent system can further include the step of performing authentication of the Web client in case that the Web client accesses the Web server.

The method of operating the agent system can further include the step of restoring modified or deleted agent service in the registry in case that the agent service stored in the knowledge base is modified or deleted.

### EFFECT OF THE INVENTION

As described above, in accordance with the present invention, since a client can rapidly and conveniently determine a CALM in which a service is stored by accessing a CALM-based directory facilitator in which a service requested through a Web server is stored without confirming whether or not the service exists by accessing plural CALMs. Since the client can search the service by accessing the corresponding CALM, a search time can be remarkably shortened.

In accordance with the present invention, the service can be searched by accessing the CALM-based directory facilitator in which the service requested through the Web server is stored without a professional knowledge about a multi-agent platform.

In accordance with the present invention, since a service agent which provides a service in which an agent service is stored in the CALM can advertise the service provided by itself to the client, the client can recognize and search more various kinds of services.

### BRIEF DESCRIPTION OF THE DRAWINGS

FIG. 1 and FIG. 2 is a constitution diagram showing a configuration of an agent system using a CALM capable of searching an agent service through a Web in accordance with the present invention;

FIG. 3 is a constitution diagram showing a configuration of the CALM capable of searching the agent service through the Web in accordance with the present invention;

FIG. 4 is a diagram showing a structure of a DF agent description of the agent service;

FIG. 5 is a diagram showing an XML schema-based service description belonging to the DF agent description in accordance with the present invention; and

FIG. 6 is a flow chart for an operation method of the agent system using the CALM capable of searching the agent service through the Web in accordance with the present invention.

### DETAILED DESCRIPTION OF THE INVENTION

Hereinafter, a CALM capable of searching an agent through a Web in accordance with the present invention, an agent service using the same, and an operation method of an agent system will be described in detail with reference to the accompanying drawings.

Prior to the description, an agent service provider is defined as ‘a service client’, a client searching an agent service by accessing a CALM-based DF to be described later in person is defined as ‘a user client’, and a client searching the agent service by accessing a Web-based DF through a Web server is defined as ‘a Web client’.

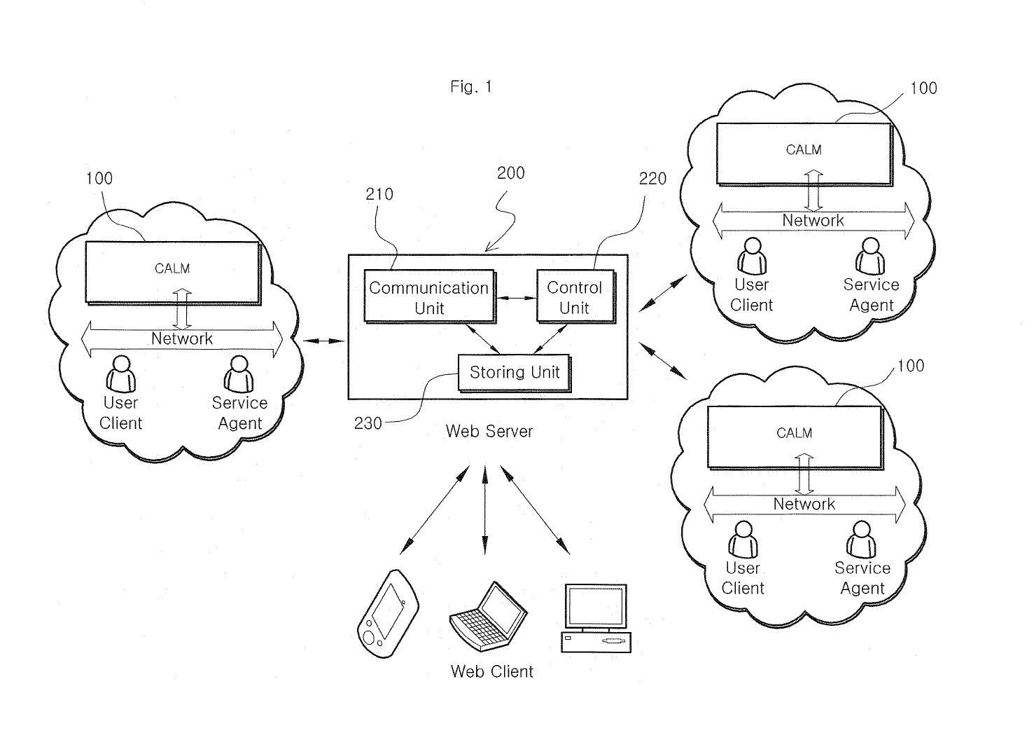

As shown in FIGS. 1, 2 and 3, the agent system using a CALM 100 having a Web-based directory facilitator for searching an agent service in accordance with the present invention includes the CALM 100 having a CALM-based directory facilitator (hereinafter, referred to as ‘a CALM-based DF’) 110, a Web-based directory facilitator (hereinafter, referred to as ‘a Web-based DF’) 120 and a message transport system 130, and a Web server 200.

The CALM provides an optimal flexibility and an optimal efficiency of an agent platform as a self-control context-aware community middleware. The directory facilitator which is a component of the CALM is an agent serving as a yellow page and serves as a storage storing services provided by agents activated in an agent platform.

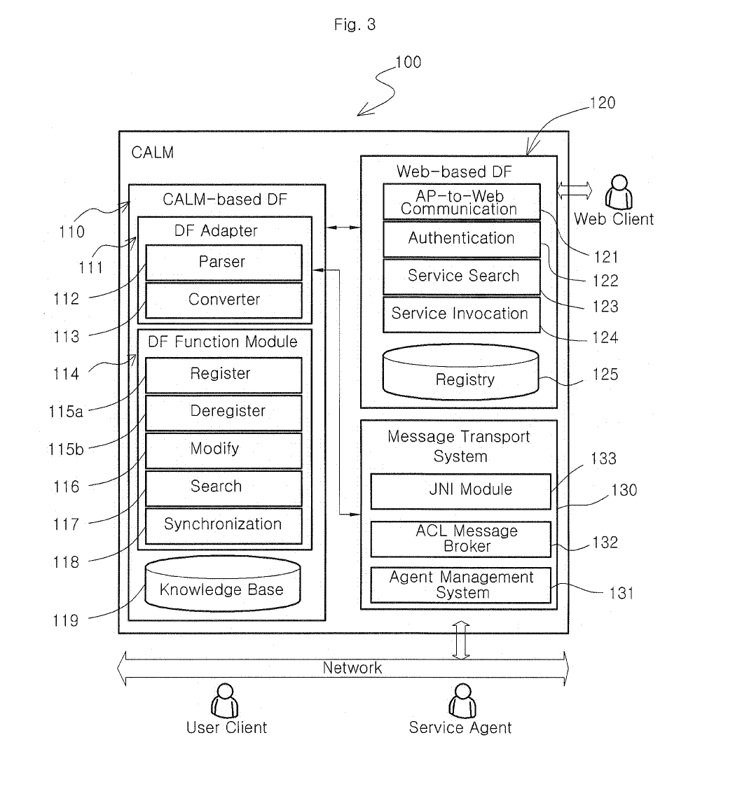

As shown in FIG. 3, the CALM-based DF 110 includes a DF adapter 111, a DF function module 114 and a knowledge base 119.

The DF adapter 111 includes a parser 112 and a converter 113.

The parser 112, as a module for processing an ACL which is a communication language for interagent communication, is constituted of an ACL message parser that receives, parses and controls an ACL message transmitted from the message transport system 130 to be described later, and a content message parser that parses a content message containing an actual service description among parsed ACL messages.

The converter 113 is constituted of a content message composer for composing the content message with the service description of a service searched by a search 117 to be described later.

The DF function module 114 is prepared to register, to deregister, to modify and to search the service in the knowledge base 119. The DF function module 114 controls the knowledge base 119 while being in direct communication with the knowledge base 119 which is the service storage.

A Register 115a performs a function of registering a DF agent description including a new service description in the knowledge base 119.

That is, when the agent prepares a description of its own service, the registers stores the DF agent description in the knowledge base 119. At this time, an AID (Agent ID) of the agent and the service description are stored in the knowledge base 119 as Key and Value, respectively.

A Deregister 115a performs a deregistering function of removing the DF agent description stored in the knowledge base 119 according to a service agent's request.

A method of deleting a service description which is a corresponding value by searching the AID of the agent is used as a method of deregistering a specific DF agent description.

A Modify 116 performs a function of modifying the DF agent description stored in the knowledge base 119 according to an agent’ request.

In the service modification, the service agent prepares a DF agent description of a format which the service agent desires to modify and a service description template so as to modify the service description to search and delete the DF agent description having the AID of the corresponding agent in the knowledge base 119, and newly registers the DF agent description prepared by the agent.

A Search 117 can request the DF to search one or more agents to meet a user client's requirement. An agent which desires to the service prepares the service description of a target service to be searched and searches the service by comparing the service description with the service description of the DF agent description stored in the knowledge base 119.

A search result is returned in an array format of the DF agent description. The service can be searched by selectively assigning attributes including a service name, a type, protocol, ontology, a language, a property, an owner, an AID, and the like for the service to be searched.

A synchronization module 118 restores a modified or deregistered agent service in a register 125 to be described later in case that the agent service stored in the knowledge base 119 is modified or deregistered.

The knowledge base 119 is a storage for storing the DF agent description 140 for the service provided by the service agent. The knowledge base 119 uses a Hash map structure in which the service description is stored in correspondence with a key value by setting the agent ID as the key value.

As shown in FIG. 3, the Web-based DF 120 includes registry, AP-to-Web communication, service search and service invocation.

The AP-to-Web communication (hereinafter, referred to as “a communication module 121”) attempts connection between the Web client and an application of the Web-based DF 120.

And, a service search (hereinafter, referred to as “a service search module 123”) searches a service which the Web client requests in the Registry (hereinafter, referred to as “a registry 125”).

Herein, the service search module 123 searches the agent service which the Web client requests among the agent services stored in the knowledge base 119 and stores the searched agent service in the registry 125 in case that the agent service which the Web client requests does not exist in the registry 125.

Previously searched agent service is stored in the Registry 125 so as to more conveniently and rapidly search the agent service which the Web client previously requested in the future.

The service invocation (hereinafter, referred to as “an invocation module 124”) provides the agent service searched by the service search module 123 to the Web client through the communication module 121.

The Web-based DF 120 may include Authentication (hereinafter, referred to as “an authentication module 122”). The authentication module 122 performs the authentication of the Web client and assures consistent connection of the authenticated Web client when the Web client accesses the communication module 121.

The message transport system 130 is a communication system for allowing the user client which desires to search the agent service by directly accessing the CALM 100 rather than passing through the service client or the Web server 200 to access the CALM-based DF 110.

The message transport system 130 includes an AMS (Agent Management System) 131, an ACL message broker 132 and a JNI module 133. The components are apparent to those skilled in the art, and thus description thereof will be omitted.

The Web server 200 allows the Web client to access the Web-based DF 120 on a Web by the use of terminals such as a desktop, a notebook, and the like.

Herein, plural CALMs 100 are prepared and the agent services stored in the CALMs 100 may be different from each other.

Accordingly, the Web server 200 allows the Web client to access the CALM 100 in which the agent service requested by the Web client who is accessing the CALM through the Web server 200 is stored by storing agent service lists stored in the registries 125 of the plural CALMs 100.

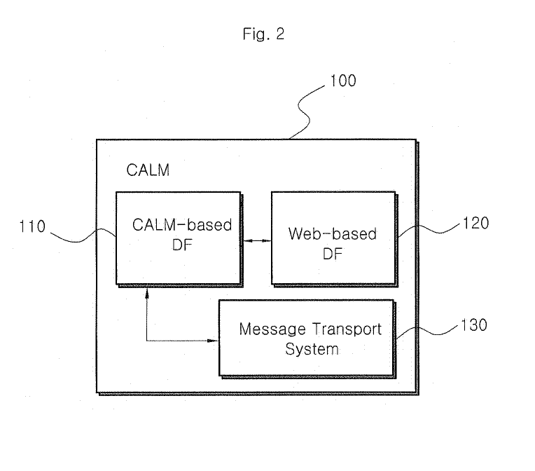

As shown in FIGS. 1 and 2, the Web server 200 includes a communication unit 210, a control unit 220 and a storing unit 230.

The communication unit 210 allows communication between the communication module 121 of the Web-based DF 120 and the Web client.

The storing unit 230 stores the service lists prepared by being based on service descriptions 143 of the agent services stored in the registries 125 of the plural CALMs 100.

The control unit 220 displays the service lists stored in the storing unit 230 to the Web client when the Web client accesses the communication unit 210 of the Web server 200.

At this time, when the Web client referring to the service lists selects any one among the plural CALMs 100, the control unit 220 allows the Web client to access the CALM 100 selected through the communication unit 210.

In case that an agent service search result performed by the service search module 123 does not exist, the control unit 220 updates the service lists according to the corresponding result at the time of transferring the corresponding result to the Web client.

The content of the corresponding agent service may be slightly modified at the time of providing the searched agent service to the Web client by the use of the invocation module 124. Accordingly, the control unit 220 can update the service lists on the basis of the service description of the agent service provided to the Web client so as to provide the accurate service lists.

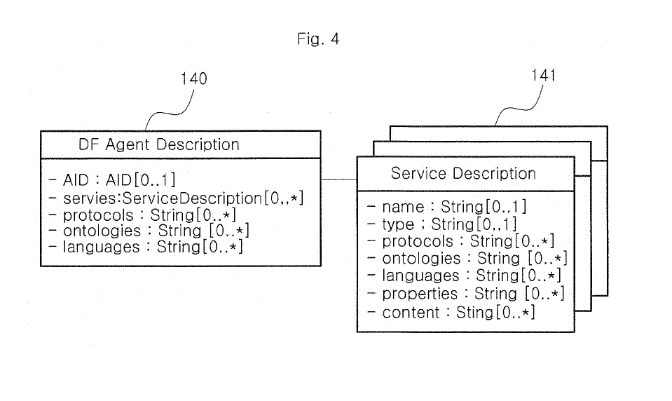

FIG. 4 shows a structure of the DF agent description of the agent service stored in the knowledge base 119. The DF agent description 140, as the description of the agent providing the service, is constituted of parameters such as the AID which is the agent ID, a service description object, the used protocol, the used ontology and the used communication language.

The DF agent description 140 is a message format to meet an FIPA standard specification. The AID and the DF agent description 140 are stored in the knowledge base 119 in pairs.

A service description object 141, as the service description object belonging to the DF agent description 140, is constituted of parameters such as the service name, the service type, the used protocol, the used ontology, the service owner and the attribute. The service description is stored in the knowledge base 119 with belonging to the DF agent description 140.

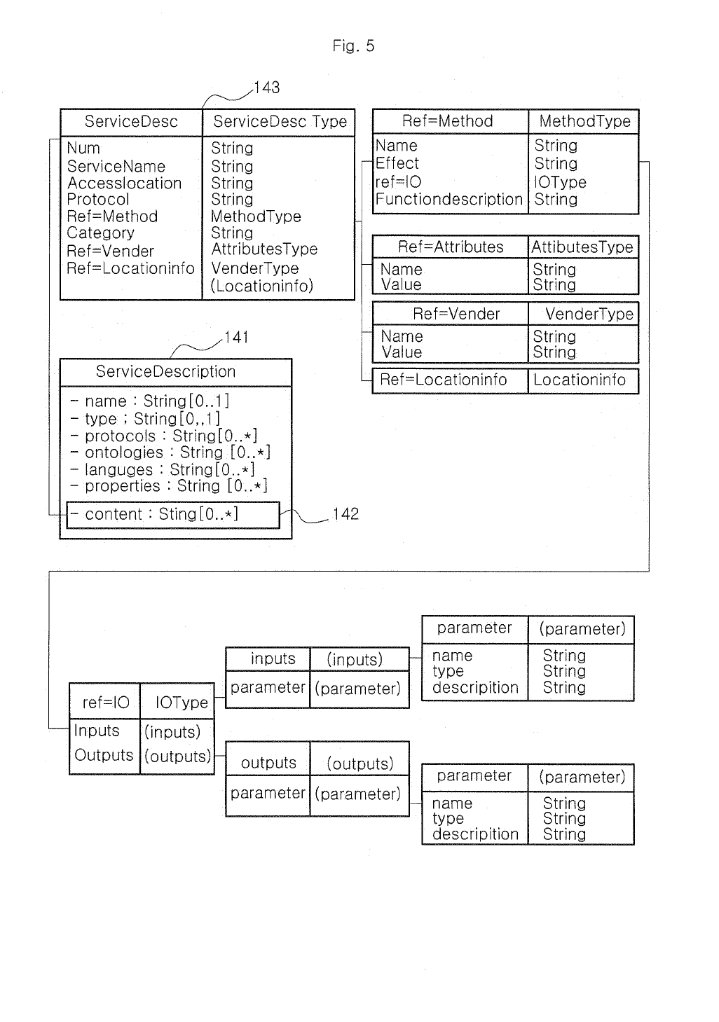

FIG. 5 shows the service description 143 in which a content 142 of the service description object 141 belonging to the DF agent description 140 in accordance with the present invention is converted based on an XML schema.

The service agent constitutes the description of the agent service provided by itself by the XML schema-based service description 143 in the DF agent description 140.

Parameters belonging to the service description 143 includes Num indicating a serial number given to the agent service, ServiceName indicating the service name, Accesslocation indicating a location of the agent service for accessing the agent service in an IP address or a port number, Protocol of the service, Ref=Method indicating a current state at the time of invocating the corresponding agent service, Categor indicating a category to which the corresponding service belongs, Ref=Vender indicating a provider providing the corresponding service, and Ref=LocationInfo indicating a location in a physical space or a logical space where the corresponding agent service is located.

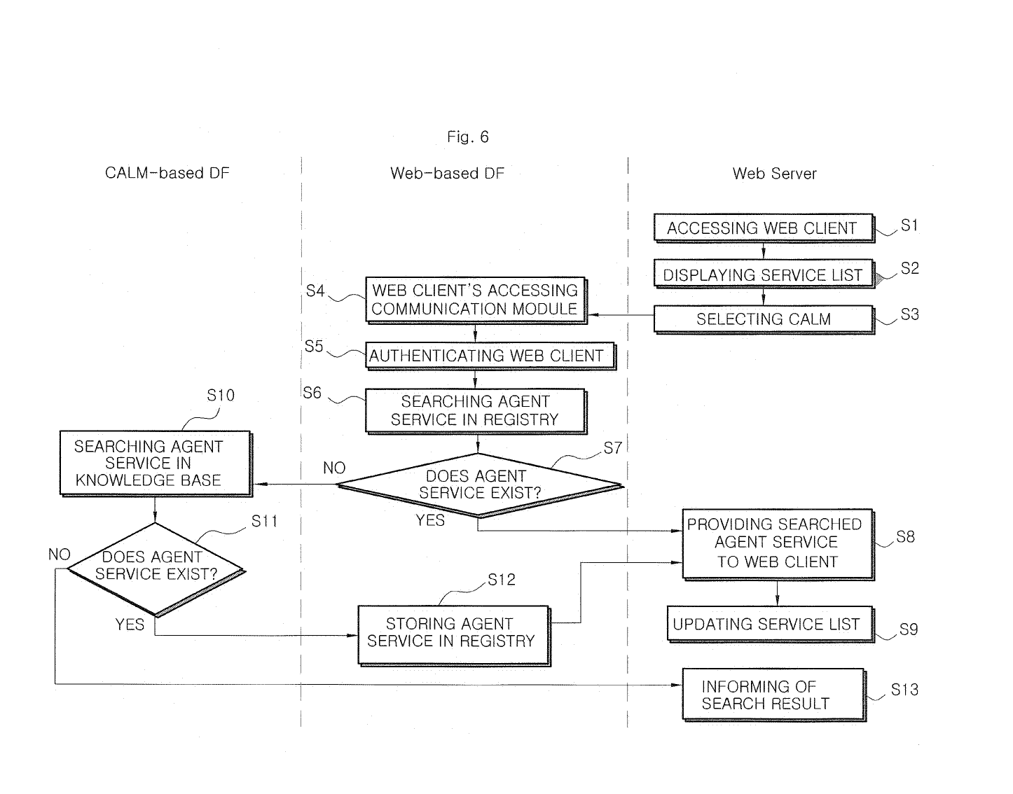

Hereinafter, the operation method of the agent system using the CALM capable of searching the agent service through the Web in accordance with the present invention will be described with reference to FIG. 6.

When the Web client accesses the Web server 200 (S1), the control unit 220 of the Web server 220 displays the service lists stored in the storing unit 230 to the Web client (S2).

Herein, the Web client referring to the service lists selects the CALM 100 in which the corresponding agent service is stored (S3).

Herein, even though an desired agent service does not exist in the service lists, the Web client may select the CALM 100 in which plural similar agent services are stored.

The control unit 220 of the Web server 200 allows the Web client to access the communication module 121 of the CALM 100 selected by the Web client through the communication unit 210 (S4).

The Web client accessing the communication module 121 of the CALM 100 is authenticated by the authentication module 122 (S5) and the agent service which the Web client requests is searched in the registry 125 by the service search module 123 (S6).

Herein, in case that the desired agent service is searched in the registry 125, the invocation module 124 provides the agent service which the Web client requests stored in the registry 125 to the Web client through the communication module 121 (S8).

The control unit 220 of the Web server 200 updates the service lists on the basis of the service description of the agent service provided to the Web client (S9).

Meanwhile, in a step S7, in case that the agent service which the Web client requests does not exist in the registry 125 in view of the search result by the service search module 123, the service search module 123 searches the agent service which the Web client requests in the knowledge base 119 of the CALM-based DF 110 (S10).

Herein, when the agent service is searched in the knowledge base 119 by the service search module 123 (S31), the invocation module 124 store the corresponding agent service in the registry 125 and provides the communication module 121 to the Web client (S8). In this case, since the corresponding agent service is newly stored in the registry 125, the control unit 220 of the Web server 200 updates the service lists on the basis of the service description of the corresponding agent service (S9).

Meanwhile, when the agent service which the Web client requests is not searched in the knowledge base 119 (S11) after the step S10, the service search module 123 informs the Web client of the search result that the corresponding agent service does not exist through the communication module 121 (S13).

Next, the Web client designates the attributes such as the service name, type, protocol, ontology, language, property, owner, AID, content, and the like of a target agent service which the Web client requests by accessing the Web-based DF 120 through the Web server 200 to rapidly search the CALM 100 in which the agent service is stored by each condition.

Since the attributes can be selectively inputted and searched through a Web browser, it is possible to obtain a visible effect for the agent service which the Web client desires only with an abbreviate selection function for the attributes without a detailed description for inputting a message related to an existing service request.

Although preferred embodiments of the present invention have been illustrated and described, it will be apparent to those skilled in the art that various changes and modification of the embodiments may be made without departing from the principle and spirit of the present invention. The scope of the present invention is defined by the appended claims and the equivalents thereof.

What is claimed is:

1. A CALM capable of searching an agent service through a Web, comprising a Web-based directory facilitator,
wherein the Web-based directory facilitator includes:
a communication module which a Web client accesses;
a registry in which the agent service is stored;
a service search module for searching the agent service which the Web client requests from the registry; and
an invocation module for providing the agent service searched by the service search module to the Web client through the communication module.

2. The CALM as recited in claim 1, further comprising a CALM-based directory facilitator including a knowledge base in which the agent service provided from a service client is stored,
wherein the service search module searches the agent service which the Web client requests among the agent services stored in the knowledge base in case that the agent service which the Web client requests does not exist in the registry, and
wherein the invocation module stores the agent service searched in the knowledge base by the service search module in the registry and provides the agent service to the Web client through the communication module.

3. The CALM as recited in claim 1, wherein the CALM-based directory facilitator includes a synchronization module for restoring modified or deleted agent service in the registry in case that the agent service stored in the knowledge base is modified or deleted.

4. The CALM as recited in claim 2, wherein the CALM-based directory facilitator includes a synchronization module for restoring modified or deleted agent service in the registry in case that the agent service stored in the knowledge base is modified or deleted.

5. The CALM as recited in claim 1, wherein a content of a service description object of the agent service stored in the registry is an XML schema (eXtensible Markup Language schema)-based service description including one or more among:
a serial number given to the agent service;
a name of the agent service;
location information of the agent service for accessing the agent service;
a protocol of the agent service;
information on a method of executing the service;
a category of the agent service;
information on a provider indicating a provider of the agent service; and
circumferential information of a location of the agent service.

6. The CALM as recited in claim 2, wherein a content of a service description object of the agent service stored in the registry is an XML schema (eXtensible Markup Language schema)-based service description including one or more among:
a serial number given to the agent service;
a name of the agent service;
location information of the agent service for accessing the agent service;
a protocol of the agent service;
information on a method of executing the service;
a category of the agent service;
information on a provider indicating a provider of the agent service; and
circumferential information of a location of the agent service.

7. The CALM as recited in claim 1, wherein the Web-based directory facilitator further includes an authentication module for performing authentication of the Web client in case that the Web client accesses the communication module.

8. The CALM as recited in claim 2, wherein the Web-based directory facilitator further includes an authentication module for performing authentication of the Web client in case that the Web client accesses the communication module.

9. An agent system capable of searching an agent service through a Web, comprising:
a Web server which a Web client accesses; and
a CALM having a Web-based directory facilitator, wherein the Web-based directory facilitator includes:
a communication module which a Web client accesses through the Web server;
a registry in which the agent service is stored;
a service search module for searching the agent service which the Web client requests from the registry; and
an invocation module for providing the agent service searched by the service search module to the Web client through the communication module.

10. The agent system as recited in claim 9, further comprising a CALM-based directory facilitator having a knowledge base in which the agent service provided from a service client is stored,
wherein the service search module searches the agent service which the Web client requests among the agent services stored in the knowledge base in case that the agent service which the Web client requests does not exist in the registry, and
wherein the invocation module stores the agent service searched in the knowledge base by the service search module in the registry and provides the agent service to the Web client through the communication module.

11. The agent system as recited in claim 9, wherein the CALM-based directory facilitator includes a synchronization module for restoring modified or deleted agent service in the registry in case that the agent service stored in the knowledge base is modified or deleted.

12. The agent system as recited in claim 10, wherein the CALM-based directory facilitator includes a synchronization module for restoring modified or deleted agent service in the registry in case that the agent service stored in the knowledge base is modified or deleted.

13. The agent system as recited in claim 9, wherein a content of a service description object of the agent service stored in the registry is an XML schema (eXtensible Markup Language schema)-based service description including one or more among:
a serial number given to the agent service;
a name of the agent service;
location information of the agent service for accessing the agent service;
a protocol of the agent service;
information on a method of executing the service;
a category of the agent service;
information on a provider indicating a provider of the agent service; and
circumferential information of a location of the agent service.

14. The agent system as recited in claim 10, wherein a content of a service description object of the agent service stored in the registry is an XML schema (eXtensible Markup Language schema)-based service description including one or more among:
a serial number given to the agent service;
a name of the agent service;
location information of the agent service for accessing the agent service;
a protocol of the agent service;
information on a method of executing the service;
a category of the agent service;
information on a provider indicating a provider of the agent service; and
circumferential information of a location of the agent service.

15. The agent system as recited in claim 13,
wherein plural CALMs are prepared, and
wherein the Web server includes:
a storing unit in which a service list prepared by being based on a service description of the agent service stored in the registry is stored;
a communication unit for allowing communication between the communication module of the Web-based directory facilitator and the Web client; and
a control unit for displaying the service list to the Web client, allowing the Web client to access any one of the plural CALMs by the communication unit, and updating the service list stored in the storing unit on the basis of whether or not the agent system searched by the service search module exists or the service description of the agent service provided to the Web client by the invocation module.

16. The agent system as recited in claim 14,
wherein plural CALMs are prepared, and
wherein the Web server includes:
a storing unit in which a service list prepared by being based on a service description of the agent service stored in the registry is stored;
a communication unit for allowing communication between the communication module of the Web-based directory facilitator and the Web client; and
a control unit for displaying the service list to the Web client, allowing the Web client to access any one of the plural CALMs by the communication unit, and updating the service list stored in the storing unit on the basis of whether or not the agent system searched by the service search module exists or the service description of the agent service provided to the Web client by the invocation module.

17. The agent system as recited in claim 9, wherein the Web-based directory facilitator further includes an authentication module for performing authentication of the Web client in case that the Web client accesses the communication module through the Web server.

18. The agent system as recited in claim 10, wherein the Web-based directory facilitator further includes an authentication module for performing authentication of the Web client in case that the Web client accesses the communication module through the Web server.

19. A method of operating the agent system capable of searching the agent service through the Web as recited in claim 9, comprising the steps of:
accessing a Web server by a Web client;
displaying a service list prepared by being based on a service description of the agent service to the Web client by the Web server;
accessing a CALM in which the agent service to be requested by the Web client is stored by the Web client;
searching the agent service which the Web client requests in the registry by the service search module; and
providing the agent service which the Web client requests, stored in the registry to the Web client through the communication module by an invocation module.

20. The method of operating the agent system as recited in claim 19, further comprising the steps of:
preparing a CALM-based directory facilitator having a knowledge base in which the agent service provided from a service client is stored;
searching the agent service which the Web client requests in the knowledge base in case that the agent service which the Web client requests does not exist in the registry in view of a search result by the service search module; and
storing the agent service searched in the knowledge base by the service search module in the registry and providing the agent service to the Web client through the communication module by the invocation module.

21. The method of operating the agent system as recited in claim 19, further comprising the steps of:
preparing the CALMs in multiple;
storing the service list prepared by being based on the service description of the agent service stored in the registry of the plural CALMs in the Web server;
displaying the service list to the Web client accessing the Web server;
accessing any one communication module in which the agent service which the Web client requests is stored among the CALMs through the Web server; and
updating the service list stored in the service description on the basis of whether or not the agent system searched by the service search module exists or the service description of the agent service provided to the Web client by the invocation module.

22. The method of operating the agent system as recited in claim 20, further comprising the steps of:
preparing the CALMs in multiple;
storing the service list prepared by being based on the service description of the agent service stored in the registry of the plural CALMs in the Web server;
displaying the service list to the Web client accessing the Web server;
accessing any one communication module in which the agent service which the Web client requests is stored among the CALMs through the Web server; and
updating the service list stored in the service description on the basis of whether or not the agent system searched by the service search module exists or the service description of the agent service provided to the Web client by the invocation module.

23. The method of operating the agent system as recited in claim 19, further comprising the step of: performing authentication of the Web client in case that the Web client accesses the Web server.

24. The method of operating the agent system as recited in claim 20, further comprising the step of: performing authentication of the Web client in case that the Web client accesses the Web server.

25. The method of operating the agent system as recited in claim 19, further comprising the step of: restoring modified or deleted agent service in the registry in case that the agent service stored in the knowledge base is modified or deleted.

26. The method of operating the agent system as recited in claim 20, further comprising the step of: restoring modified or deleted agent service in the registry in case that the agent service stored in the knowledge base is modified or deleted.
